(19) United States
(12) Patent Application Publication
(10) Pub. No.: US 2023/0162560 A1
(43) Pub. Date: May 25, 2023

(54) Method for structured gaming on an external activity.

(71) Applicant: Supported Intelligence, LLC, East Lansing, MI (US)

(72) Inventors: Neal Patrick Anderson, Lansing, MI (US); Jeffrey Paul Johnson, East Lansing, MI (US)

(73) Assignee: Supported Intelligence, LLC, East Lansing, MI (US)

(21) Appl. No.: 17/531,849

(22) Filed: Nov. 22, 2021

(51) Int. Cl. G07F 17/32; G06Q 50/34

(52) U.S. Cl. CPC G07F 17/323; G07F 17/3262; G07F 17/3276; G07F 17/3288; G06Q 50/34

(57) ABSTRACT

A method for providing users gaming advice based upon the structure of a game based upon an external activity, where the external activity operates independently of the game. The user provides parameters and receives gaming advice allowing the user to increase their odds of winning by picking high-value picks, even when the high-value picks appear to have poor traditional odds.

### CROSS REFERENCE TO RELATED APPLICATIONS

This application is a continuation of U.S. application Ser. No. 16/581,592 which is a U.S. application Ser. No. 15/456,512, filed Mar. 11, 2017, which claims the benefit of U.S. Provisional application 62/307,248, and which are hereby incorporated by reference in their entireties.

### BACKGROUND OF THE INVENTION

### Field of the Invention

The invention relates to games played based upon other activities. More specifically, the invention relates to fantasy sports, March Madness brackets, and other sports (and games) where winning is determined by an structure independent of only picking a winner, a loser or a over/under.

### Description of Related Art

Betting or wagering games based upon external (or independent) activities are already extremely popular, and are growing in popularity. Weekly fantasy sports leagues where users pick players to form fantasy teams and the players' performance on their real teams is used to fill in their fantasy performance have become ubiquitous. Likewise, the NCAA Men's College Basketball playoff tournament (commonly called March Madness) has a longstanding tradition of office or neighbor bracket pools where users fill out a predicted bracket and collect points based on how many games they correctly predict. Similar to both traditional fantasy sports leagues and bracket pools the growth industry of e-sports also has extensive fantasy style structured games. Users draft or pick players from e-sports teams for weekly league style competitions or discrete tournaments and depending on how those players do during the relevant period the user's fantasy team is awarded points and ranked against other users.

In all these games there is an external activity, for example the March Madness tournament, weekly (or daily) football or baseball games or e-sports tournaments, that provides a basis for a structured gaming system that the user attempts work to their advantage while competing against other users. Acting as a pretend general manager, a user attempts to identify and pick external activity participants undervalued by others. The structured gaming system rewards picking the winner not picked by others. Therefore the users goal is not just to pick a winner, as everyone can identify the most likely team to win based only upon the odds, but to identify the under-appreciated or uncommon picks that will bring more value than merely picking the most obviously talented or higher rated player or team.

Several unreliable methods of picking teams or players for structured gaming based upon an external activity exist, including user intuition, picking user favorites, randomly selecting some upsets, hunting for non-public or barely published information, relying on “expert” analysis or calculating meta-statistics in attempt to identify under-valued selections. However, current methods

face numerous issues. For example, relying on an expert's analysis requires identifying someone who actually has deep insight into the external activity. Use of meta-statistics likewise requires identifying a meta-statistic that is more than accidental correlation, such as famous statistics about candidate heights and elections or only tangentially linked statistics such as time of possession and wins in most sports games. Likewise, random selection of upsets is unsatisfactory because it turns a game of skill and valuation into a lottery. Finally the time-intensive hunt for non-public or barely published information is also unsatisfactory because it requires the user to spend their limited time and energy attempting find and verify leaks of highly protected information.

### BRIEF DESCRIPTION OF THE DRAWINGS

FIG. 1. is an example of a User-Interface asking the user about popular selections in the user's external activity structure.

FIG. 2. is an example of a User-Interface with the user inputting a popular selection in the user's external activity structure.

FIG. 3. is an example of a User-Interface showing output to the user of the selections the user should select in the user's external activity structure.

FIG. 4. is a flowchart showing an embodiment of a method of taking public information combining it with the external activity structure and the gaming structure to identify high-value selections.

FIG. 5. is a formula one for expected relative score.

FIG. 6. is a formula for desirability.

FIG. 7. is a diagram showing an activity external structure, and an example of desirability calculation.

FIG. 8. is a flowchart showing a step in identifying high-value selections in the gaming structure based on the external activity.

FIG. 9. is a flowchart showing steps of filling in the the gaming structure according to selection value.

FIG. 10. is a diagram showing parts of a computer system capable of receiving input and displaying output as well as performing processing steps.

### DETAILED DESCRIPTION OF THE INVENTION

User determination of high-value selections within a gaming structure based upon an external activity requires the identification of selections that produce value based upon outperforming other users' likely selections. These outperforming selections are high-value selections within the gaming structure and the ability to methodically identify high-value selections instead of relying upon expert analysis, the time consuming and error prone search of less-publicly known information, or the use of meta-statistics that may reflect creator bias or correlation allows the user to improve their chances of winning by playing other players, not the game. For example:

(1) A popular selection is over-valued by many other players, such as when a team historically has had success in a tournament. By focusing the user's attention on outplaying other players by identifying high-value picks instead of popular picks (or picks that are otherwise over-rated), the user increases the user's odds of success within the game structure.

(2) A selection is well-known to be high value, such as when a higher rated team faces a substantially lower rated team which for some unknown reason reliably beats the higher rated team, i.e. the lower rated team has the higher rated team's “number.” In this case selecting the upset may not be a high-value selection because many other players will also select the “obvious” upset. By examining the odds and known selection information the method allows the user to model and estimate other users' behavior and plan around it.

(3) A selection is so popular that selecting it as well does not provide any value to the user. Most people will select “a sure thing” believing it to be so obvious that doing otherwise would be foolish. This method identifies cases in which it may be sub-optimal to winning the game (the structured gaming activity) to select the “sure thing” because of the interaction with the other users.

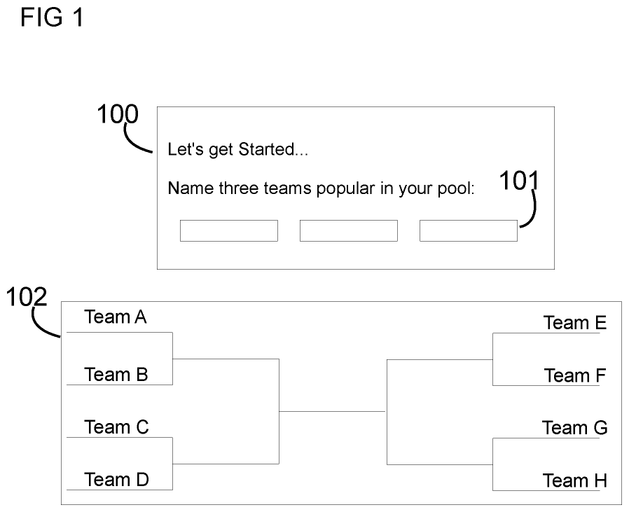

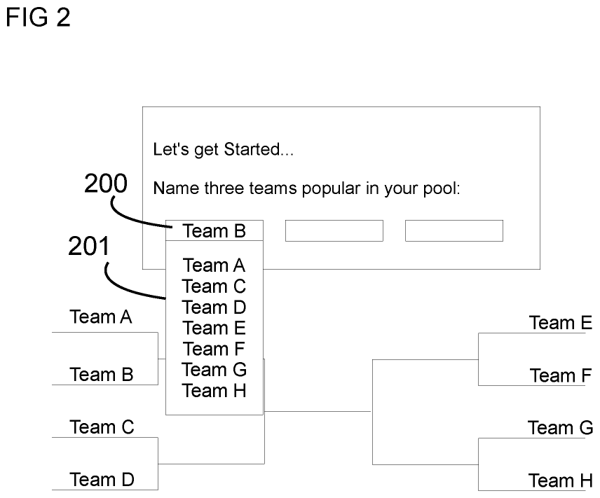

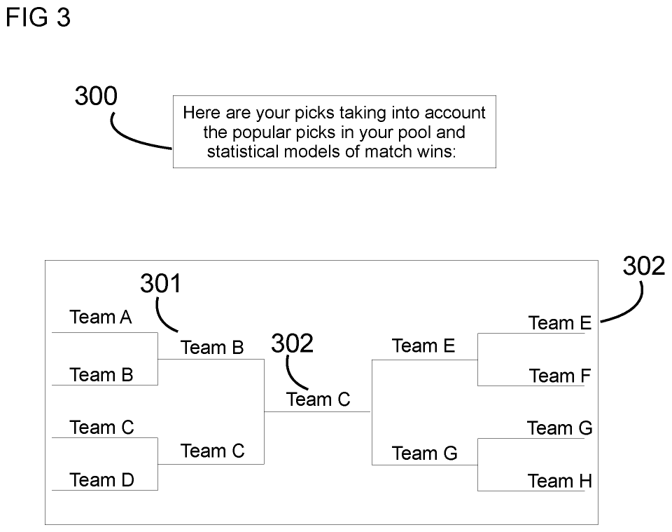

FIGS. 1, 2 and 3 show an exemplary user-interface allowing user to input information about a gaming structure for an external activity, here a single elimination tournament. The user is prompted for information about the specific gaming structure the user is participating in, this information could include pick frequency (as in FIG. 1), sub-objectives of the gaming structure, special rules for the gaming structure not found in standard gaming structures, the option to input more information, or the option to switch external activities or gaming structures, or the option to edit the gaming structure. FIGS. 1 and 2 show the inputting of information, while FIG. 3 shows one way of providing the user with selection instructions after the user has performed the method. The instructions could be provided in a list form, with options for further user editing, or to restart the process with changed inputs, or be automatically entered into the gaming structure.

FIG. 1 shows an exemplary user interface for assisting the user in inputting some or all of the required information. FIG. 1 has UI element 100, a box prompting the user for information, UI element 101 an input box and UI element 102 displaying information about the external activity.

UI element 100 prompts the user for information, in this case three popular teams in the user's pool (assuming a priori knowledge that the external activity structure is a single elimination bracket style tournament). UI element 100 may be of requesting more information, such as input of the external activity structure (or selection among already included formats such as pools into single elimination or double elimination). Additionally, there may be other (not shown) user input prompts or boxes allowing the entry of other relevant information, including match odds, more (or less) popular picks, especially unpopular picks or user favored teams, game structure information, additional user objects, and user risk tolerance.

UI element 101 is capable of receiving the user input requested by UI element 100. The user input may be limited, for example only selection from a drop-down list of participant names, radio buttons, free form entry, video or audio recognition, or any other means of information input including links to websites containing the requested information as discussed for UI element 100.

UI element 102 displays information about the external activity, this information may be already known (for example, in an application specific to one external activity and one gaming structure) or may fill in as the user continues to be asked from information by UI element 101 and inputs the information using UI element 102. Altogether, the user interface allows the user to input an external activity structure, a gaming structure, public information and may allow the user to further tweak the method to account for non-public information or user preference. The gaming structure takes the external activity structure and transforms it into decisions that the user makes about what will happen in the external activity and rewards the user for outperforming other users at predicting some facet of what happens in the external activity. The user has access to public information about the external activity such as odds, over/under lines and may include what other users have already selected for the current gaming structure or similar gaming structures. [0072] The external activity structure may be a single sports game, a discrete sports tournament, an ongoing league, an e-sports league a fantasy sports league, periodic competitions or combinations of the above. The external activity structure may be ongoing or not. Furthermore the external activity structure has elements capable of being broken down in the game structure into users (including the other users, also called participants) who make numerous decisions beyond merely indicating a win or loss for a single team or player.

The gaming structure takes the external activity structure and transforms it into a set of decisions about what will happen during the external activity where the user is rewarded for how the user performs in competition with the other participants. This creates a situation where participants are rewarded not for merely identifying which player or team wins, but in correctly selecting the player or team that wins when other participants did not select them to win, or correctly selecting other particular outcomes when other participants did not select that particular outcome.

The public information includes the odds of winning for teams, selection rates from the current gaming structure or similar gaming structures and may include other information such as meta-statistics or expert rankings. The public information must be capable of being quantized in some fashion, but need not be meaningfully ordinal, i.e. a tier-list breaking teams or players into approximately equivalent groups but not representing the quality difference between the groups beyond better or worse is usable, as are precise Vegas-style odds.

The user interface may allow the user to select from among the public information sources, use different weighting, modeling or solution algorithms, or insert user defined preferences into the method. For example, in a fantasy e-sports league the user may choose to draft high-value players except for a favorite player that the user will always draft regardless of value. In another example, a user may select a favorite team in a single-elimination tournament regardless of value. Furthermore the user may choose to input non-public information or modify the definition of high-value. For example, the gaming structure may have an entry fee and have most of the rewards allocated to coming in first in the gaming structure, but the user would rather consistently make back the entry fee.

FIG. 2 is an exemplary user-interface similar to FIG. 1 but showing one way information may be input by the user. FIG. 2 shows a selected team 200 and a selectable drop-down box 201. The selected team 200 in (selected in response to a prompt from FIG. 1, UI element 100) represents the user's selection for a popular team in their pool. This information may be acquired by the user asking other participants in the pool, the user guessing based upon popular picks in other local pools, or other information such as commentator picks. The drop-down box 201 presents all of the teams in the pool, however the user may be prompted with a curtailed list of pre-sorted names based upon a heuristic popularity measurement or allowed to enter the information free-form.

FIG. 3 is a exemplary user-interface with UI element 300 content information, UI element 301 showing a second round selection, UI element 302 showing the selection for winner of this bracket and UI element 303 generally showing the external activity structure and the selections. For external activity structures with many participants, matches or stages the output may be displayed across multiple screens, simplified or sent to the user in a list form providing selection instructions.

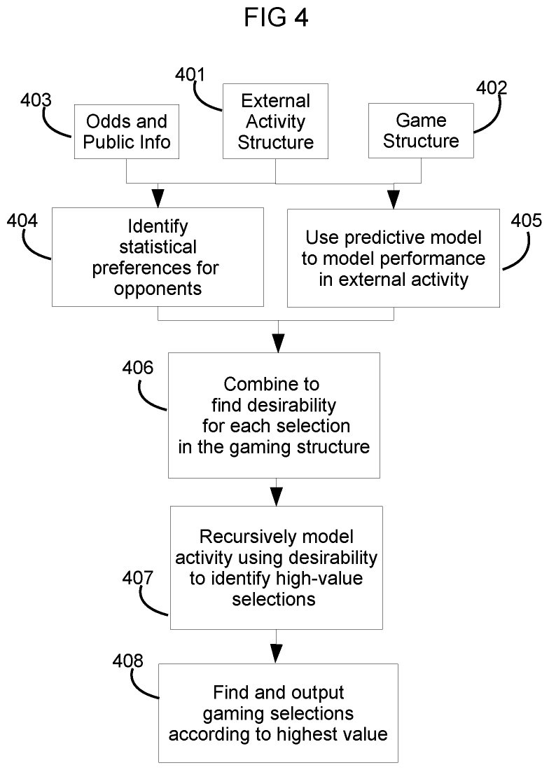

FIG. 4 shows a flowchart of an exemplary embodiment starting with input of the external activity structure in step 401, the game structure in step 402 and odds and public info in step 403. These steps may be performed in various orders. In one embodiment (using a mobile device) steps 402 and 403 happen before the user even downloads the mobile device application, then the user provides some information (such as popular picks) and the application checks for current odds and public info again. In step 404 statistical preferences for opponents' selections is modeled. In step 405 a predictive model for winning in the external activity is used. Steps 404 and 405 may be performed contemporaneously or in either order. In step 406 the predictive model from step 405 and the opponent selections from 404 are combined to create a desirability score, hereafter referred to as desirability, for all the selections in the game structure for matches in the external activity. In step 407 the game structure is recursively modeled to find all selectable combinations of desirabilities and find the highest value set of selections. In step 408 the output of step 407 is used to identify and output the selections.

This embodiment may be adapted for many different gaming structures and external activity structures, specifically both single elimination brackets and non-single elimination bracket structures. In certain gaming structures (such as on-going fantasy leagues or e-sports) the relative value of the selections may be calculated differently or tied to alternative outcomes other than winning or losing. For example, the user is playing a weekly fantasy sport league where the fantasy league players each draft a team from the teams active in the league that week. The user chooses in which round of the draft to select high-value players, while still filling a roster (i.e. an American football team cannot only draft quarterbacks).

In step 401 the external activity structure is input. The input may take the form of the user input, where the user inputs the various relevant elements or they may be included. In one example the user has a mobile device with pre-loaded applications, each application allowing access to information and games about one external activity structure.

In step 402 the game structure is input. The input may take the form of the user input, where the user inputs the various relevant elements or they may be included (for example, the user's mobile device may have an application that only allows the user to play one game structure for a yearly college basketball tournament). In another example, there may be many games based around a single elimination college basketball tournament, with many different rules variations. Because of the rule variations that affect the game structure the user should select a single game structure. However, the user may use a general rule set, with decreased results quality. The game structure may be largely identical to the external activity structure with the addition of rewards for correct selections of winning teams, however it may also vary widely.

For example, the game structure may be created out of a single football game where points are assigned for correctly guessing the first play of each drive before the ball is snapped with plays similar to the run play awarded more points (i.e. if the play is a triple option hand-off run up between the tackles and a selection of any type of running play awards more points than selecting a throwing play such as a “four wide receiver hail mary”). In another example, a game structure may be created out of guessing which players will be subbed in during a hockey game with the most points awarded for correct picks, less points for correct position and the fewest points, no points, or negative points for an incorrect position.

In step 403 odds and public info are input (or identified from pre-existing sources such as an on-mobile-device database). The odds and public info includes public information as described above but may include other available information such as private tips, or other material non-public information such as information about injury status. This step may also include the input of picks the user believes will be popular in their pool (game structure). Additionally, there may be specific prompts or locations for material non-commonly known (although technically public) information not usually used or available for the most common external activity structures or game structures. For example, in an e-sports players often engage in public practice, a user can (far more easily than in most professional sports) identify specific strategies professionals have been practicing. This may give more of an edge when it is included in the predictive model.

In step 404 a set of statistical preferences is created estimating the chance that other users will select a team or player in the game structure. This may be done by examining currently available public information, when known, about selection frequency, or may be inferred using a regression from prior time period data or from another model, for example a model based on weighted odds plus a notoriety level and expert analysts selection data. Additionally, the set of statistical preferences may be imported or used by referencing a per-existing data set.

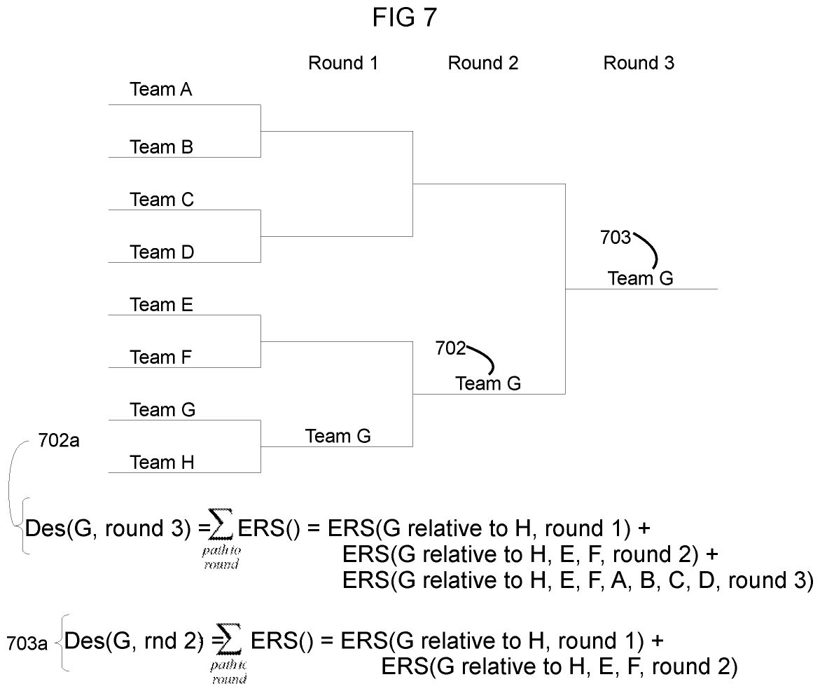

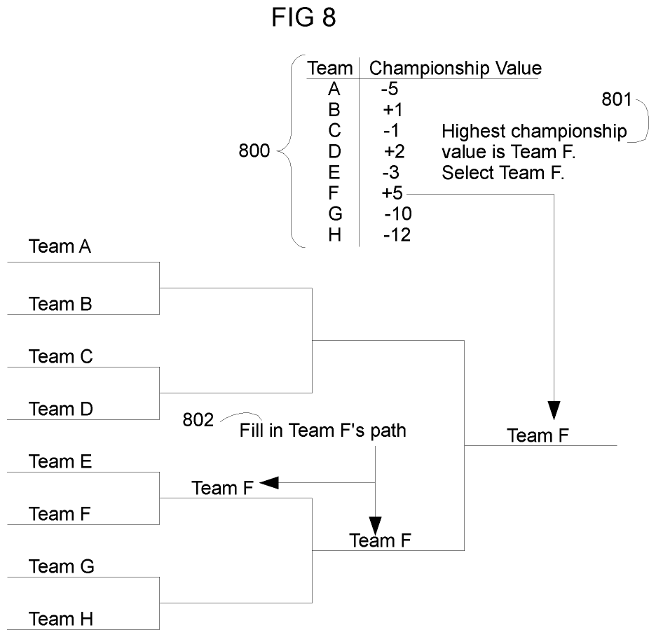

In step 405 a predictive model is used to estimate a team's or player's (the team or player participating in the external activity) likelihood of defeating other teams or players in a single elimination bracket (as explored in FIGS. 7 and 8). The predictive model need not solely estimate win likelihood, but could estimate any type of performance in the external activity. In an e-sports or fantasy sports embodiment, value in the gaming structure may be based on particular players outperforming other players at their role. In this case the predictive model may estimate players' level of performance in the external activity. Additionally, the predictive model may be imported or used by referencing a per-existing data set, modeling algorithm or other means of predicting outcomes.

In many of these cases the predictive model must be carefully tailored to the gaming structure, because it must answer questions directly relevant the game structure. If the game structure relates to calling plays before the snap, then the predictive model must predict plays to be called before the snap. If the game structure relates to in-game income earned by an e-sports professional during the first ten minutes of a game than the predictive model must predict in-game income earned by an e-sports professional during the first ten minutes.

The predictive model may be any available predictive model, it could be as simple as selection of a higher seeded team, betting odds or it may incorporate other information such as injury information and specific team match-up histories.

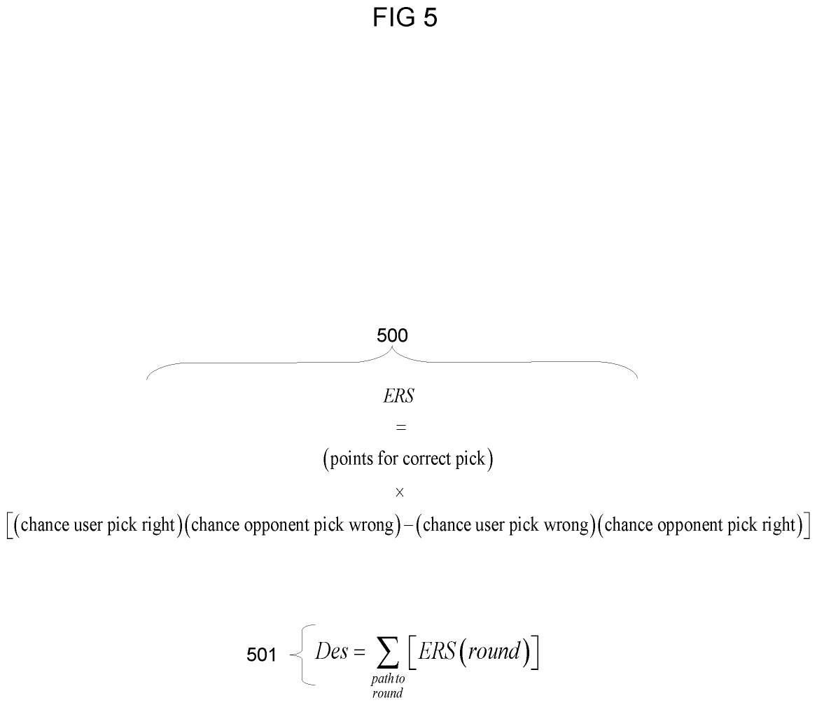

In step 406 the predictive model from step 405 and the opponent selections from step 404 are combined to find the desirability of each selection in the gaming structure. Finding desirability of a team or competitor may be begun by creating a set of expected relative scores for each element of the gaming structure. The expected relative score (ERS) represents the expected points from making a selection, relative to the other players in the gaming structure. More specifically, ERS is a comparison of a given team with all other teams that could reach that game in the tournament (including, teams that it would have had to play before reaching that game in the tournament). One way to model ERS is given in FIG. 5, formula 500. In formula 500 a “chance user pick wrong” does not necessarily mean the team lost in that round, the team may have lost in that round, an earlier round, or for some other reason not reached that round. Furthermore, the user may “pick wrong” in a variety of ways “(chance user pick wrong)*(chance opponent pick right)” represents the sum of the individual products of the chance of each way a user could pick wrong, and the chance an opponent could pick correctly in that situation.

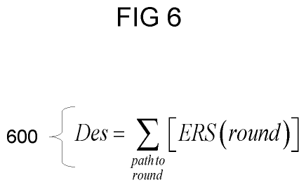

A set of expected relative scores for each selection are combined to find the desirability of each selection, essentially expanding consideration to include the paths taken to the selection instead of only considering the selection in isolation. The desirability is created for each team (or player). The desirability of a team represents the desirability of the team at some particular point in the gaming structure based off the external activity structure. One formula for desirability is given in FIG. 6, formula 600, for an external activity structure of a single elimination bracket. FIG. 7 shows an example of desirability for a single elimination bracket of 8 teams and finding the desirability from expected relative score. In FIG. 7 the user picks G (identified as 702) to win into round 2, then the possibility of H getting to round 2 instead of G is also accounted for. In this case it is possible to represent the desirability as the sum of ERS values along the path through the bracket to a particular round location (formula 702a, desirability of G in round 3 and formula 703a, desirability of G in round 2).

Then in step 407 recursive modeling techniques are used to explore all possible interactions of desirability in the external activity structure and determine the highest value set of selections. One way to do this is to compose a Markov Decision problem using desirability as the reward function, and the transitions provided by the external activity structure. For example, in a single elimination tournament, each choice is filled in as winner, its desirability identified and then the path that the winning team would take is back filled. Next a set of sub-tournaments are constructed. In each sub-tournament, each eligible choice is filled in as winner, and its desirability identified. This process is repeated recursively, until all sub-tournaments have been considered. The championship value for each choice is determined by combining the desirability of the championship choice and the desirability of the winner of each sub-tournament. Similarly, values for each choice winning each sub-tournament are determined.

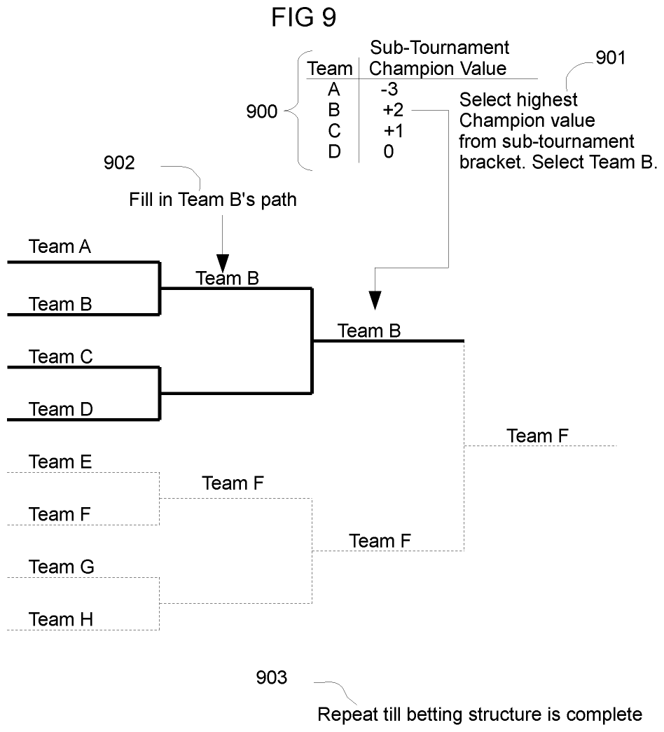

FIGS. 8 and 9 provide an example of finding the highest value set of game selections using the championship and sub-tournament values from step 407. In FIG. 8 table 800 provides a table of example championship values for teams A through H. First the highest championship value team (in this example team F) is selected (indicated by reference numeral 801). Then team F is selected and F's path through the external activity structure (which is structured the same as the gaming structure in this example) is filled in shown by thicker line weight, (reference numeral 802). Then FIG. 9 shows the creation of a sub-tournament for second place team, where table 900 shows the sub-tournament championship values, reference numeral 901 shows the selection of the highest championship value (here team B) and reference numeral 902 shows filling in team B's path through the sub-tournament. This process is performed as many times as needed until all required selections have been identified.

In step 408 game selections are output from the solution found in step 407. The output may be directly input to the gaming structure, output as individual prompts allowing time for the user to enter it into the gaming structure or for more-complicated gaming structures output in multiple tables with explanations of how to use the tables. When the user is using a mobile device the output may directly input to a gaming structure of the user's selection in this step.

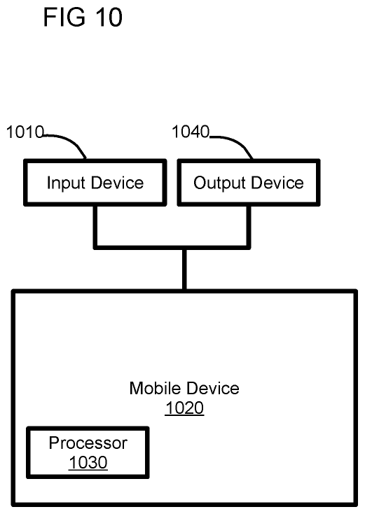

FIG. 10 shows an input device 1010, a mobile device 1020, a processor 1030 and an output device 1040. The input device may be an device with a screen, which may be capable of displaying output as well (thus acting as an output device 1040 as well). The processor 1030 is a processor capable of collecting the input information from the input device 1010, performing the steps as described above, and outputting required the information to the output device 1040. FIGS. 1, 2 and 3 show exemplary user-interfaces showing various examples of input information that may be received through the input device 1010. The output device 1040 shows the output information as discussed above in step 408.

We claim:

1: A method of entering a game based on outcomes of another game comprising a sports tournament, a guessing tournament, a processor, an output device and a input device,
(a) the sports tournament being between a plurality of competitors, the sports tournament having at least two stages where competitors, compete against other competitors in competitions, the competitions determining competitor progression through stages of the sports tournament, each competitor's progression through the stages of the tournament being their competitor's path, each competition having odds estimating the relative chances of the participating competitors winning the competitions;
(b) the guessing tournament being between a plurality of players, the guessing tournament having selections where each player guesses the winner of each competition between competitors in the sports tournament, the guessing tournament rewarding correct picks and rewarding the players with more correct picks more than players with fewer correct picks;
(c) the processor assisting a user, the user one of the players of the guessing tournament, the user in selecting competitors for the guessing tournament by
(i) identifying, using user input and available selection odds a set of statistical preferences, the set of statistical preferences representing statistical information about other player's guesses, for the players in the guessing tournament;
(ii) predicting likely outcomes for the sports tournament;
(iii) combining the likely outcomes for the sports tournament with the statistical preferences for the players in the guessing tournament to identify a desirability in the guessing tournament of each possible selection in the sports tournament;
(iv) finding a value of selecting each competitor in the last stage of the guessing tournament by, (A) measuring a value in the guessing tournament of each competitor in the final stage of the sports tournament through the desirability of the competitor reaching the final stage combined with a value in the guessing tournament of all the other competitor's paths through the competitions of the sports tournament, and (B) the value in the guessing tournament of each competitor's path through the competitions of the sports tournament being recursively determined by the desirability of that competitor reaching their final round combined with the value of the remaining competitors eligible for that competitor's path through the earlier stages of the sports tournament;
(v) identifying the highest value set of selections for the guessing tournament;
(vi) the processor outputting to the user the selections to make in the guessing tournament.

2: A method according to claim 1, wherein the sports tournament is a single elimination bracket tournament.

3: A method according to claim 2, wherein the guessing tournament progressively rewards correct later-stage selections more than earlier stage selections.

4: A method according to claim 1, wherein the guessing tournament rewards correctly selecting less common player selection option for a competitions more than more common player selections.

5: A method according to claim 1, wherein the guessing tournament progressively rewards correct later-stage selections more than earlier stage selections and the guessing tournament rewards correctly selecting less common player selection option for a competition more than more common player selections.

6: A method according to claim 1, wherein the output to the user includes the selections to make in the guessing tournament and at least one other set of sub-optimal selections.

7: A method according to claim 1, wherein the step of identifying the user input allows the user to select one or more competitors to select in the guessing tournament regardless of team value in the guessing tournament.

8: A method of entering a game based on outcomes of another game comprising a sports tournament, a guessing tournament, a processor, an output device and a input device,
(a) the sports tournament being between a plurality of competitors, the sports tournament having at least two stages where competitors, compete against other competitors in competitions, the competitions determining competitor progression through stages of the sports tournament, each competitor's progression through the stages of the tournament being their competitor's path, each competition having odds estimating the relative chances of the participating competitors winning the competitions;
(b) the guessing tournament being between a plurality of players, the guessing tournament having selections where each player guesses the winner of each competition between competitors in the sports tournament, the guessing tournament rewarding correct picks and rewarding the players with more correct picks more than players with fewer correct picks;
(c) the processor assisting a user, the user one of the players of the guessing tournament, the user in selecting competitors for the guessing tournament by
(i) identifying, using user input and available selection odds a set of statistical preferences, the set of statistical preferences representing statistical information about other player's guesses, for the players in the guessing tournament;
(ii) predicting likely outcomes for the sports tournament;
(iii) combining the likely outcomes for the sports tournament with the statistical preferences for the players in the guessing tournament to identify a desirability in the guessing tournament of each possible selection in the sports tournament;
(iv) finding a value of selecting each team in the final stage of the guessing tournament by, (A) measuring a value in the guessing tournament of each team in the final stage of the sports tournament through the desirability of the team reaching the final combined with a value in the guessing tournament of all the other team's paths through the competitions of the sports tournament, and (B) the value in the guessing tournament of each team's path through the competitions of the sports tournament being recursively determined by the desirability of that team reaching their final round combined with the value of the remaining competitors paths through the earlier stages of the sports tournament;
(v) identifying the highest value team in each competition of the guessing tournament;
(vi) the processor displaying on a graphical user interface to the user the selections to make in the guessing tournament.

9: A method according to claim 8, wherein the sports tournament is a single elimination bracket tournament.

10: A method according to claim 9, wherein the guessing tournament progressively rewards correct later-stage selections more than earlier stage selections.

11: A method according to claim 8, wherein the guessing tournament rewards correctly selecting less common player selection option for a competition more than more common player selections.

12: A method according to claim 8, wherein the guessing tournament progressively rewards correct later-stage selections more than earlier stage selections and the guessing tournament rewards correctly selecting less common player selection option for a competition more than more common player selections.

13: A method according to claim 8, wherein the output to the user includes the selections to make in the guessing tournament and at least one other set of sub-optimal selections.

14: A method according to claim 8, wherein the step of identifying the user input allows the user to select one or more competitors to select in the guessing tournament regardless of team value in the guessing tournament.

15: A method of using a mobile device to enter a game based on outcomes of another game comprising a sports tournament, a guessing tournament, a mobile device and a remotely located service provider server,
(a) the sports tournament being between a plurality of competitors, the sports tournament having at least two stages where competitors, compete against other competitors in competitions, the competitions determining competitor progression through stages of the sports tournament, each competitor's progression through the stages of the tournament being their competitor's path, each competition having odds estimating the relative chances of the participating competitors winning the competitions;
(b) the guessing tournament being between a plurality of players, the guessing tournament having selections where each player guesses the winner of each competition between competitors in the sports tournament, the guessing tournament rewarding correct picks and rewarding the players with more correct picks more than players with fewer correct picks;
(c) the mobile device assisting a user, the user one of the players of the guessing tournament, the user in selecting competitors for the guessing tournament by identifying, using user input and available selection odds a set of statistical preferences, the set of statistical preferences representing statistical information about other player's guesses, for the players in the guessing tournament;
(d) the mobile device with in conjunction with a remotely located service provider server dynamically predicting likely outcomes for the sports tournament and combining the likely outcomes for the sports tournament with the statistical preferences for the players in the guessing tournament to identify a desirability in the guessing tournament of each possible selection in the sports tournament;
(e) then the mobile device in conjunction with a remotely located service provider server dynamically finding a value of selecting each team in the final stage of the guessing tournament by, (A) measuring the value in the guessing tournament of each team in the final stage of the sports tournament through the desirability of the team reaching the final combined with the value in the guessing tournament of all the other team's paths through the competitions of the sports tournament, and (B) the value in the guessing tournament of each team's path through the competitions of the sports tournament being recursively determined by the desirability of that team reaching their final round combined with the value of the remaining competitors paths through the earlier stages of the sports tournament;
(f) then the mobile device displaying on a graphical user interface to the user the selections to make in the guessing tournament.

16: A method according to claim 15, wherein the sports tournament is a single elimination bracket tournament.

17: A method according to claim 16, wherein the guessing tournament progressively rewards correct later-stage selections more than earlier stage selections.

18: A method according to claim 15, wherein the guessing tournament rewards correctly selecting less common player selection option for a competition more than more common player selections.

19: A method according to claim 15, wherein the guessing tournament progressively rewards correct later-stage selections more than earlier stage selections and the guessing tournament rewards correctly selecting less common player selection option for a competition more than more common player selections.

20: A method according to claim 15, wherein the output to the on the graphical user interface user includes the selections to make in the guessing tournament and at least one other set of sub-optimal selections.

21: A method according to claim 15, wherein the step of identifying the user input allows the user to select one or more competitors to select in the guessing tournament regardless of team value in the guessing tournament.
